(19) United States
(12) Patent Application Publication
(10) Pub. No.: US 2014/0255900 A1
(43) Pub. Date: Sep. 11, 2014

(54) DUAL TASK MENTAL DEFICIENCY ASSESSMENT SYSTEMS AND METHODS

(71) Applicant: UNIVERSITY OF GEORGIA RESEARCH FOUNDATION, INC., Athens, GA (US)

(72) Inventors: Michael S. Ferrara, Athens, GA (US); Phillip D. Tomporowski, Athens, GA (US)

(73) Assignee: UNIVERSITY OF GEORGIA RESEARCH FOUNDATION, INC., Athens, GA (US)

(21) Appl. No.: 13/791,948

(22) Filed: Mar. 9, 2013

(51) Int. Cl. G09B 5/08

(52) U.S. Cl. CPC G09B 5/08
USPC 434/362

(57) ABSTRACT

Systems and methods for simultaneously conducting a non-reflex motor test and a cognitive test are described herein. This dual-test methodology compares a baseline performance for an individual to a diagnostic performance for the individual to determine whether an individual has suffered a concussion or other mental deficiency. The baseline performance data is collected before a suspected injury, and the diagnostic performance data is collected after the suspected injury. The methodology may also be used to determine how an individual is recovering from a concussion or mental deficiency by comparing later performances to earlier performances.

### BACKGROUND

The present invention relates to dual task mental deficiency assessment systems and methods.

Decisions concerning an athlete's return-to-play (RTP) following a concussion are currently made on the basis of multiple indices. Over the past decade, neuropsychological testing has increasingly become part of the concussion assessment and in making RTP decisions. Several computer-based neuropsychological test batteries have been developed and marketed for evaluation of concussion effects. The advantage of computerized testing has been purported to be that the tests provide fine-grain analyses of basic cognitive functions such as visual scanning, information processing speed, executive function, and memory. These tests can be used as part of RTP decision-making.

Recently, the merits of this approach have been questioned, particularly in terms of the sensitivity and reliability of the tests employed. Thus, an improved methodology is needed to provide a truer assessment of whether an individual has suffered a mental deficiency, such as a concussion.

### SUMMARY

Various implementations of the invention described herein illustrate the use of a dual-task testing methodology to provide a truer assessment about whether an individual has suffered a mental deficiency, such as a concussion. The methodology employs a non-reflex motor test and a cognitive test that are conducted simultaneously. For an athlete, this methodology may be used to determine his or her readiness for play by comparing the athlete's performance after the injury with the athlete's performance before the injury. The methodology may also be used to determine how an individual is recovering from a concussion or mental deficiency by comparing later performances to earlier performances.

In particular, a method for facilitating determination of a mental deficiency in a patient by a health service provider may include: (1) instructing the patient to perform a cognitive task; (2) instructing the patient to perform a motor task while performing the cognitive task, wherein the motor task is a non-reflex task; (3) determining a baseline performance on the cognitive and motor tasks; (4) at a later time, again instructing the patient to perform the cognitive task; (5) at the later time, again instructing the patient to perform the motor task while performing the second cognitive task; (6) determining a diagnostic performance on the cognitive and motor tasks; (7) comparing the diagnostic performance with the baseline performance to generate a comparison profile; and (8) communicating the comparison profile to the health service provider for use in determining the mental deficiency.

The non-reflex motor task may simulate a sport activity or a series of repeated intervals initiated by the patient. For example, the motor task may include a series of foot placements or a modified Harvard step test. The cognitive test may include presenting a series of symbols, such as a series of numbers and/or letters, for the patient to characterize. For example, the cognitive test may include presenting a series of letters and numbers and receiving a characterization from the patient about whether the letter is a vowel or consonant or whether the number is even or odd.

### BRIEF DESCRIPTION OF THE SEVERAL VIEWS OF THE DRAWINGS

FIG. 1 is a flow diagram of a dual testing method;

FIG. 2 is a schematic of a testing apparatus;

FIG. 3 is a schematic of a computer system;

FIG. 4 is a flow diagram of testing module;

FIG. 5 is a flow diagram of cognitive task sub-module;

FIG. 6 is a flow diagram of motor task sub-module; and

FIG. 7 is a flow diagram of an assessment module.

### DETAILED DESCRIPTION

The inventors have observed that specific combinations of motor-control tests and cognitive tests lead to changes in performance of one or both tasks. Reduced performance observed during dual-task conditions is typically explained in terms of limitations of attentional resources. In theory, individuals' attentional resources are fixed. Concurrent performance of multiple-tasks draws on limited resources to the point that reductions in performance are observed.

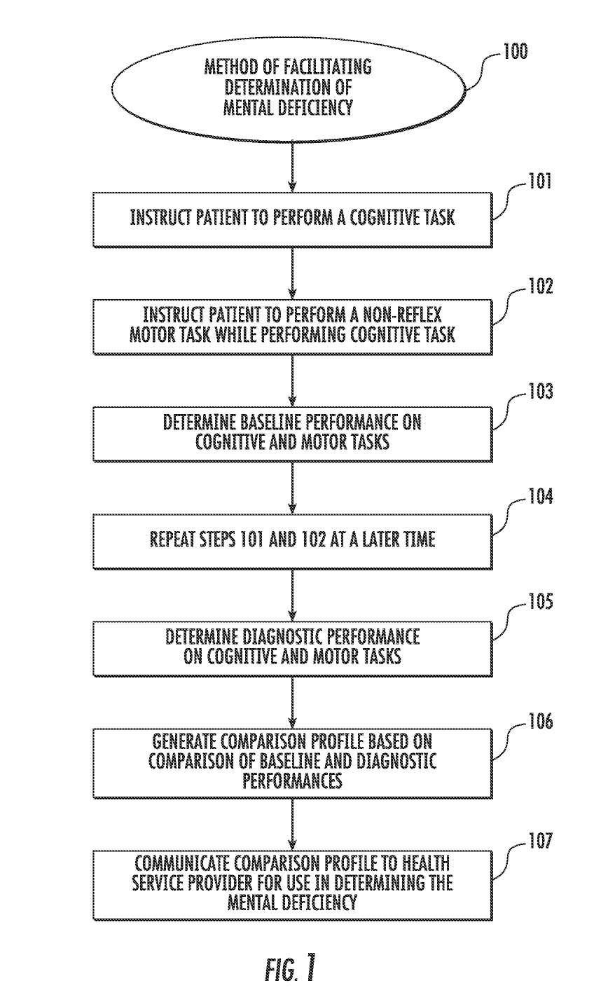

Implementations of the present invention include systems and methods for facilitating determination of a mental deficiency using dual-task testing methodology. In particular, FIG. 1 illustrates a method 100 of facilitating determination of a mental deficiency using dual-task testing methodology. The method begins at step 101 by instructing a patient to perform a cognitive task. Next, in step 102, the patient is instructed to perform a non-reflex motor task while performing the cognitive task. In step 103, a baseline performance is determined for the patient on the cognitive and motor tasks. At a later time, steps 101 and 102 are repeated, as shown in Step 104. In step 105, the patient's performance on the cognitive and motor tasks is determined for this later, diagnostic performance Next, in step 106, a comparison profile is generated based on a comparison of the baseline and diagnostic performances. Then, the comparison profile is communicated to a health service provider for use in determining a mental deficiency, as shown in step 107.

An exemplary advantage to using the above described dual task methodology is that it provides a relatively low cost method for assessing mental deficiency in field applications, such as on an athletic field. Another exemplary advantage is that the methodology simulates the conditions that challenge an athlete's decision making ability during game conditions. Specifically, the athlete is required to use the cognitive and motor systems of his or her brain simultaneously on the field. Furthermore, switch tasks are less likely to be influenced by the effects of practice, which are often seen in tests of other components of executive function.

In one implementation, steps 101 through 103 are performed before a patient presents with symptoms of a mental deficiency. If a baseline performance of the patient is not available, the method may include utilizing normalized data representing baseline performances of other individuals that are of similar gender, age, and/or engage in similar physical activity, such as playing the same sport(s) or playing a particular position in the sport.

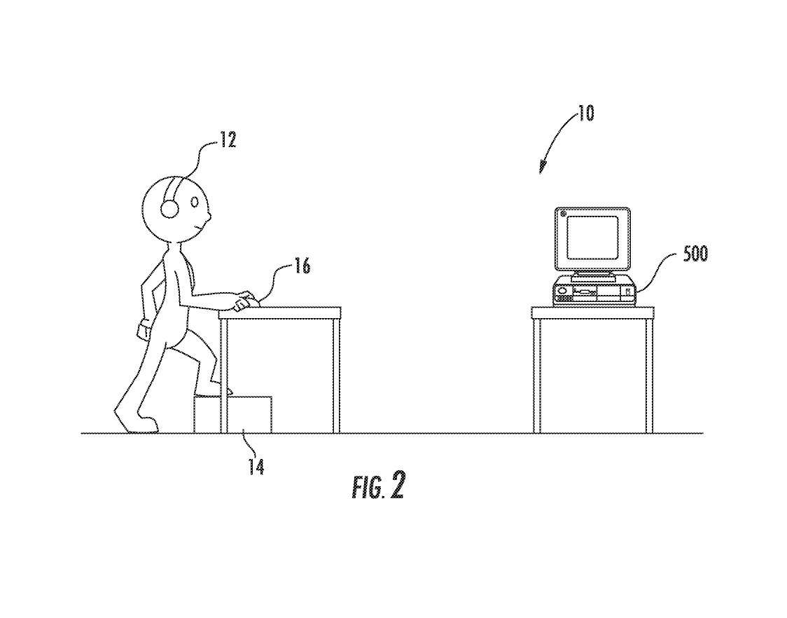

FIG. 2 illustrates an exemplary testing apparatus 10 for carrying out the method described above in relation to FIG. 1 according to one implementation. The testing apparatus 10 includes headphones 12, an input device 16, a step 14, and a computer system 500. The patient receives instructions from the computer system 500 related to the motor and cognitive tests through the headphones 12. In response to the instructions, the patient uses the step 14 to perform the motor test and the input device 16 to communicate responses to the cognitive test to computer system 500.

For the non-reflex motor test used in this implementation, the computer system 500 audibly communicates a beat of a metronome to the patient through the headphones 12.

The beat guides the frequency with which the patient steps up and down and onto and off of the step 14. The beat of a metronome may be around 30 beats per minute. In addition, the step 14 is around 8 inches high. This motor test is referred to as a modified Harvard step test.

For the cognitive test, the computer system 500 audibly communicates a series of symbols to the patient through the headphones 12. In one exemplary cognitive test, a series of letters and numbers are communicated to the patient. The patient indicates whether the letter is a vowel or consonant or whether the number is even or odd if a number. The patient indicates his or her characterization of the letters or numbers using the input device 16, such as a computer mouse, keyboard, or touch screen. For example, the patient may right click the mouse to indicate a consonant or an odd number and left click the mouse to indicate a vowel or an even number, or vice versa. The computer system 500 receives the patient's response from the input device 16 and measures the patient's answers and his or her response time. The patient may be presented with between 30 and 60 letters, numbers, or letter-number combinations (or trials) during the cognitive test, for example.

Of particular interest is the response time of the patient when the series switches between letters and numbers, which is referred to as a switch task. The response time following a switch task is used to calculate a switch-cost index for the patient. The switch-cost index reflects changes in the attention-demanding mental processes required to abandon one response set and to reconfigure a different response set. In one implementation, the cognitive test provides at least 20 switch tasks. In addition, letters or numbers are presented in a series of more than one before switching to the other. Furthermore, the cognitive test presents letters selected from a group of four vowels, four consonants, four even numbers, and four odd numbers.

Performing the motor and cognitive tests simultaneously puts an increased demand on the attentional resources available to the patient, which increases the switch-cost index. For example, during a particular test on non-concussed individuals, the response time following a switch task performed separately from a motor task may be between around 60 ms to around 110 ms, with an average response time of around 86 ms. However, the response time following a switch task performed simultaneously with a non-reflex motor task may be between around 180 ms and 250 ms, with an average response time of around 210 ms. More details about these particular tests are described below in relation to Tables 1 and 2.

Patients suffering from a concussion or other mental deficiency may show a decline in the capacity for attentional resources that are available. Accordingly, comparing the patient's baseline switch-cost index with the patient's switch-cost index after suffering an injury may guide the health service provider in assessing whether the patient has suffered a concussion from the injury.

Alternative implementations of the dual task methodology may be used. For example, the non-reflex motor test may include instructing the patient to perform repeated intervals or another sport activity, such as perform a series of foot placements (e.g., steps), ride a stationary bicycle, run or walk on a treadmill, or other appropriate non-reflexive motor task. In addition, the modified Harvard Step Test described above may be changed to include a step that is higher or lower than 8 inches or to set the metronome to another frequency. Furthermore, the metronome or other type of audible guide may be presented to the patient through other means, such as visually, person to person, or through a speaker. In some implementations, the audible guide is not presented at all.

In addition, in alternative implementations, different cognitive tests may be presented to the patient. For example, the cognitive test may present only letters, only numbers, or other types of symbols or symbol combinations. The cognitive test may require the patient to make characterizations of the letters or numbers that are presented to the patient other than vowel/consonant or even/odd, respectively. In addition, the cognitive test may present letters and numbers selected from a group of vowels, consonants, even numbers, and odd numbers that is greater than or less than four. The cognitive test may also present symbols visually, such as on a computer or touch pad screen, or audibly person-to-person or through a speaker. Furthermore, in alternative implementations, the patient may communicate his or her responses to the cognitive test verbally or by making certain gestures.

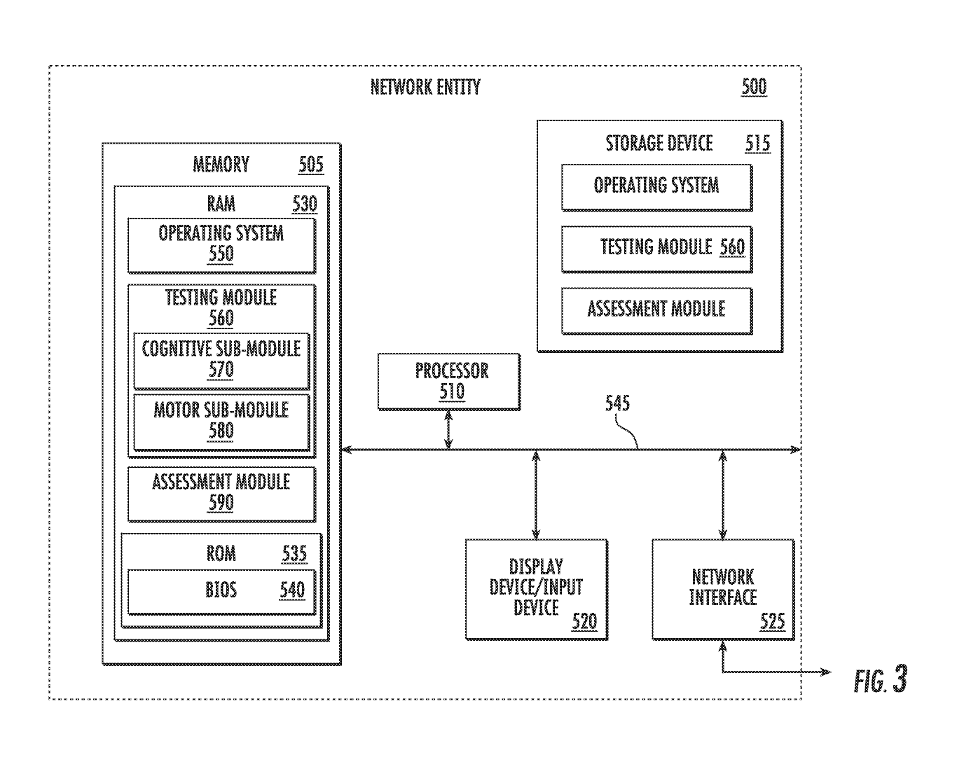

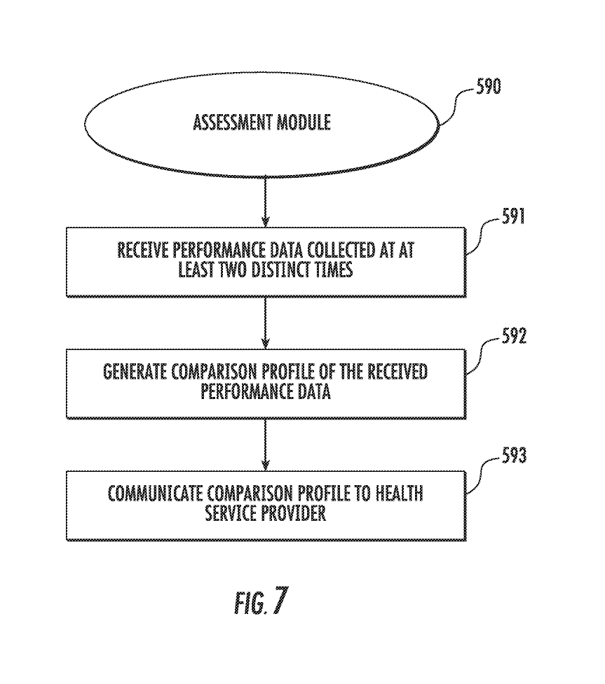

According to various implementations, the method 100 illustrated in FIG. 1 may be performed by a computer system, such as the central server 500 shown in FIG. 3. As shown in FIG. 3, a schematic diagram of a central server 500, or similar network entity, configured to implement a dual task assessment system, according to one implementation of the invention, is provided. As used herein, the designation “central” merely serves to describe the common functionality the server provides for multiple clients or other computing devices and does not require or infer any centralized positioning of the server relative to other computing devices. As may be understood from FIG. 7, in this implementation, the central server 500 may include a processor 510 that communicates with other elements within the central server 500 via a system interface or bus 545. Also included in the central server 500 may be a display device/input device 520 for receiving and displaying data. This display device/input device 520 may be, for example, a keyboard, pointing device, or touch pad that is used in combination with a monitor. The central server 500 may further include memory 505, which may include both read only memory (ROM) 535 and random access memory (RAM) 530. The server's ROM 535 may be used to store a basic input/output system 540 (BIOS), containing the basic routines that help to transfer information across the one or more networks.

In addition, the central server 500 may include at least one storage device 515, such as a hard disk drive, a floppy disk drive, a CD-ROM drive, or optical disk drive, for storing information on various computer-readable media, such as a hard disk, a removable magnetic disk, or a CD-ROM disk. As will be appreciated by one of ordinary skill in the art, each of these storage devices 515 may be connected to the system bus 545 by an appropriate interface. The storage devices 515 and their associated computer-readable media may provide nonvolatile storage for a central server. It is important to note that the computer-readable media described above could be replaced by any other type of computer-readable media known in the art. Such media include, for example, magnetic cassettes, flash memory cards and digital video disks.

A number of program modules may be stored by the various storage devices and within RAM 530. Such program modules may include an operating system 550 and a plurality of one or more modules, such as a testing module 560 and an assessment module 590. The modules 560, 590 may control certain aspects of the operation of the central server 500, with the assistance of the processor 510 and the operating system 550. For example, the modules 560, 590 may perform the functions described above and illustrated by the figures and other materials disclosed herein.

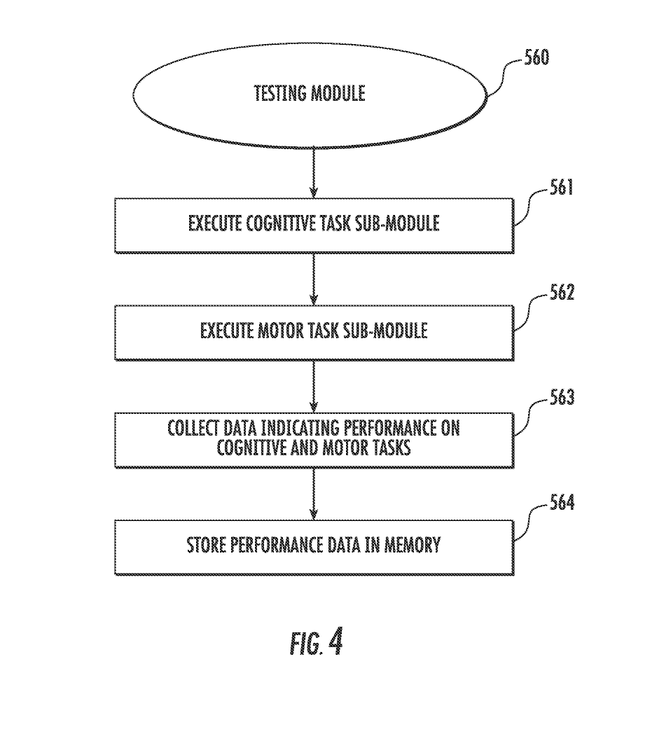

The flowchart and block diagrams in FIGS. 4-7 illustrate the architecture, functionality, and operation of possible implementations of systems, methods and computer program products according to various implementations of the present invention. Each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

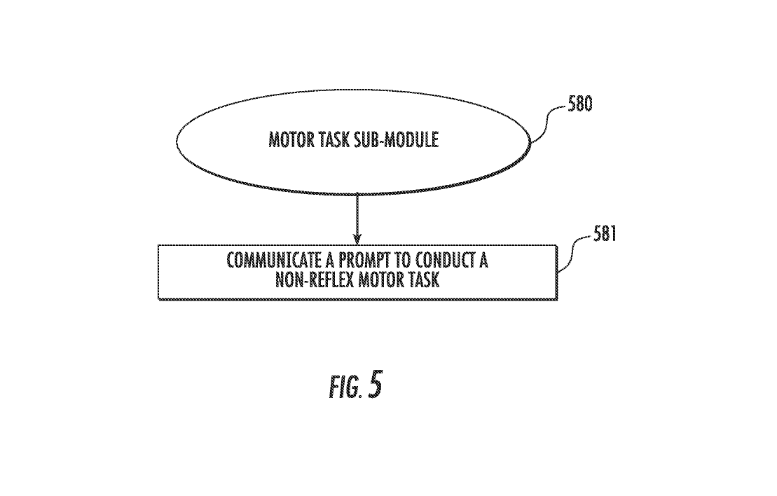

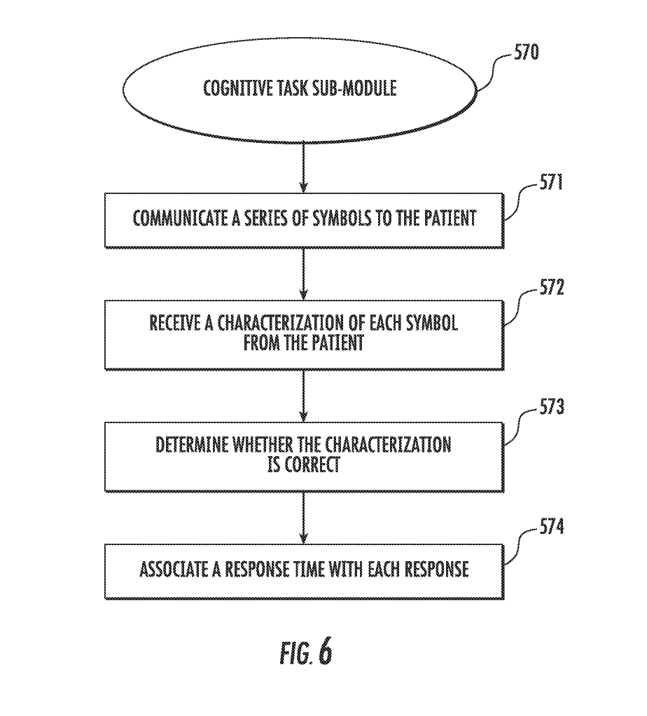

In particular, FIG. 4 illustrates exemplary steps executed by the testing module 560 according to one implementation. Beginning at step 561, the testing module 560 executes a cognitive task sub-module 570, which is described below in relation to FIG. 5. Then, at step 562, the testing module 560 executes a motor task sub-module 580, which is described below in relation to FIG. 6. In step 563, the module 560 collects data indicating the performance of the cognitive and motor tasks. Then, in step 564, the performance data is stored in a memory. According to an alternative implementation, the performance data is communicated to the assessment module 590, which is described below in relation to FIG. 7

FIG. 5 illustrates exemplary steps executed by the cognitive task sub-module 570 according to one implementation. Beginning at step 571, the cognitive task sub-module communicates a series of symbols to the patient. Next, in step 572, the cognitive task sub-module 570 receives a characterization of each symbol from the patient. In step 573, the cognitive task sub-module 570 determines whether the characterization is correct. And, in step 574, the cognitive task sub-module 570 associates a response time with each characterization. The response time measures the time elapsed from when the module 570 communicates the symbol to the patient to when the patient inputs his or her characterization of the symbol.

FIG. 6 illustrates an exemplary step executed by the motor task sub-module 580. In step 571, the motor task sub-module communicates a prompt to conduct a non-reflex motor task to the patient. In one implementation in which the patient is instructed to step onto and off of a step, the step may include an electronic sensor that communicates to the motor task sub-module 580 when the patient steps onto and off of the step. In alternative implementations in which the patient is prompted to ride a stationary bicycle or run on a treadmill, the bicycle or treadmill may include an electronic sensor that communicates the patient's cadence to the motor task sub-module 580.

FIG. 7 illustrates exemplary steps executed by the assessment module 590. In step 591, the assessment module 590 receives performance data collected at at least two different times for the patient. This performance data may be received directly from the testing module 560 or from memory. In addition, this performance data may include baseline performance data and diagnostic performance data. In step 592, a comparison profile is generated from the received performance data. Finally, in step 593, the comparison profile is communicated to a health service provider. The health service provide may use the profile to assess whether the patient is suffering from a mental deficiency. In an alternative implementation in which baseline performance data is not available for a particular patient, the assessment module 590 may retrieve normalized performance data for a group of other individuals that have similarities with the particular patient that may affect performance, such as the same gender, around the same age, involved in the same sport, or play the same position for the sport.

The inventors conducted the below described experiment to validate the theory behind the dual task assessment methodology. Through this experiment, the inventors were able to assess dual-task interference in task switching that arises when individuals simultaneously perform a motor task and a cognitive task. Participants' switch cost interference was substantial, showing that the switch index can provide researchers with a common metric to assess the influence of different types of perturbation on cognitive function. Advantageously, the methodology used in this experiment provides a relatively simple and low cost method for assessing mental deficiency in field applications, such as on an athletic field.

Fifty-nine young adults (Mage=20.32±1.84 years; 19 male) volunteered to participate in the study. Based on responses to structured medical and health history questionnaires, participants were free of neurological disease, medication influencing nervous system function, cardiovascular disease, or any other contraindication to exercise.

All participants completed two laboratory sessions scheduled one week apart. During the first session, participants were trained to perform an auditory switch task (cognitive task) and a modified Harvard Step Test (motor task). The cognitive task was described to the participant, who sat next to the computer station. Participants were instructed to listen to a series of 60 numbers and discriminate between even and odd numbers with the appropriate mouse key press (left =even, right=odd). Next, a series of 60 letters were presented and the participant was asked to discriminate between vowels and consonants with the appropriate key press (left=vowel, right=consonant). Each key press on a serial mouse was followed 100 ms later by the presentation of the next auditory stimulus. These within-category discrimination tests are referred to herein as the pure switch-task condition.

Finally, the participant was told that both letters and numbers were going to be presented. Stimuli consisted of 60 letters or numbers, which were repeated in series lengths of 2, 3, or 4, and then switched from one category to the other. The letters consisted of 4 vowels (A, E, I, and O) and 4 randomly selected consonants (B, D, L, and C). The numbers consisted of 4 even numbers (2, 4, 6, and 8) and 4 odd numbers (1, 3, 5, and 7). There were 40 non-switch and 20 switch trials, with an equal number of switches to even-odd and vowel-consonant conditions. The between-category discrimination test is referred to herein as the mixed switch-task condition. Participants were asked to respond as quickly and accurately as possible. Computer-generated letter or number stimuli were presented binaurally to a headphone via a computer system.

Following training, participants performed a series of nine tests, which differed in the type of discrimination required and the number of stimuli presented. Two test-types required within-category decisions (pure conditions): number presentation (even/odd discrimination) or letter presentation (consonant/vowel discrimination). One test-type required alternating-category decisions (mixed condition) made to numbers and letters. Participants completed separate pure- and mixed-condition tests that consisted of 30 trials, 40 trials, or 60 trials. The mixed condition tests yielded 8, 12, and 18 switch trials, which required alternation between categories. The order for test length was counterbalanced across participants. Participants performed the tests while seated and were instructed to perform each test as quickly and as accurately as possible.

During the final phase of session 1, participants were trained to perform a modified Harvard Step Test. The sound level of a metronome was adjusted and the participant was instructed to maintain a step frequency of 30 steps per minute. Following a brief practice, the participant completed five minutes of stepping on an 8-inch platform.

Session 2 took place one week later at the same time of day for each participant. The session consisted of three phases. Participants received re-training on the pure and mixed condition switch test (60 trials each). Then, the participants completed alternate forms of the 9 cognitive tests completed in session 1. Next, each participant was assigned to one of three dual-task conditions during which they performed the mixed-condition switch test while stair stepping. During the 5-minute stepping test, participants completed either five, 30-trial tests, three, 40-trial tests, or two, 60-trial tests. In each condition, participants began stepping to the metronome. After 10 seconds, the researcher signalled the participant to depress a mouse key to begin a switch test. At the end of each switch test, an auditory “stop” stimulus was presented. Participants continued stepping until the researchers signalled to depress the mouse key to begin the next switch test. Start times for each switch test were determined to ensure data were obtained during dual-task conditions. The metronome volume was lowered while participants performed the cognitive task. A researcher monitored the metronome and signalled to the participant to alter stepping pace if it deviated by more than a step from the 30 steps per minute cadence.

Twenty-one participants (Mage=21.33 ±2.03 years; 4 male) completed a third session, which took place approximately seven months (M=7.78 ±0.92 months; range=165 to 279 days) after the first session. The protocol for session 3 was a systematic replication of Session 2, performed with alternate forms of the switch task.

Separate switch-cost scores were calculated for tests comprised of 30, 40, and 60 trials. Global switch-cost scores were derived. The average response time (RT) of the two pure, within-category conditions (number and letter discrimination) was subtracted from the average RT of switch and non-switch trials in the mixed, between-category condition (see Table 1). Chronbach's Alpha was used to calculated switch-cost score stability reliability of the three tests between Session 1 and Session 2 and between Session 1 and Session 3. Dual-task interference on switch-cost scores and response errors on tests that included 30, 40, and 60 trials was assessed separately by comparing participants' single-task and dual-task performance during session 2. The frequency of response errors made during mixed, between-category tests of 30, 40, and 60 trials were converted to percentage scores. Global switch costs scores and error scores are presented in Table 2. For both global switch-cost scores and percent-error scores, an initial 3 (Group: 30, 40, 60 trials) X 2 (Condition: sitting, stepping) ANOVA was conducted to assess between-group group performance and effect size was estimated via partial eta square (pη2). In addition, separate paired t-tests were used to evaluate performance of participants assigned to 30, 40, and 60 trial conditions. Analyses were conducted using SPSS 19 software. The 0.05 rejection level was used in all analyses.

TABLE 1
Single category, mixed-category switch-task response time (ms)(SE),
and global switch costs (ms)(SE) for tests of 30, 40, and 60
trial lengths measured at three time points.

| | | |
|---|---|---|
| Single category | Mixed category | Global Switch Costs |

30-trial tests

| | | | |
|---|---|---|---|
| Day 1(n = 58) | 1251.78 (9.0) | 1339.56 (11.7) | 87.77 (10.6) |
| Day 2 (n = 58) | 1228.98 (9.5) | 1317.31 (18.6) | 88.33 (16.5) |
| Day 3 (n = 21) | 1223.3 (14.0) | 1303.39 (17.0) | 80.08 (13.4) |

40-trial tests

| | | | |
|---|---|---|---|
| Day 1 (n = 58) | 1280.68 (8.7) | 1341.83 (13.2) | 61.15 (10.4) |
| Day 2 (n = 58) | 1253.99 (9.2) | 1331.95 (15.7) | 77.96 (12.5) |
| Day 3 (n = 21) | 1251.48 (12.6) | 1313.55 (13.8) | 62.07 (9.4) |

60-trial tests

| | | | |
|---|---|---|---|
| Day 1 (n = 58) | 1267.69 (8.8) | 1385.04 (13.4) | 117.34 (10.8) |
| Day 2 (n = 58) | 1248.38 (9.1) | 1344.86 (15.2) | 96.48 (10.38) |
| Day 3 (n = 21) | 1236.89 (11.9) | 1345.03 (13.8) | 108.14 (12.3) |

TABLE 2
Global switch-cost scores (ms) (SE) and errors (percent) under single-task
and dual-task conditions for tests of 30-, 40-, and 60-trial lengths.

| | | | |
|---|---|---|---|
| Single task | | Dual task | |
| Switch cost | Errors | Switch cost | Errors |

30-trial tests (n = 19)

| | | | |
|---|---|---|---|
| 102.26 (27.5) | 2.63 | 245.15 (56.2) | 6.65 |

40-trial tests (n = 18)

| | | | |
|---|---|---|---|
| 66.96 (12.3) | 3.40 | 190.66 (29.1) | 6.55 |

60-trial tests (n = 22)

| | | | |
|---|---|---|---|
| 88.64 (9.6) | 3.41 | 210.92 (26.0) | 7.18 |

The global switch-cost scores of 58 participants were measured twice with a 7-day inter-test interval. One participant's score from the second session was unavailable for switch-task analyses. The test-retest reliability estimates were 0.64 for the 30-trial test, 0.86 for the 40-trial test, and 0.83 for the 60-trial test. The global switch-cost scores of 21 participants who completed sessions 1 and 3 were separated by approximately 7 months. The test-retest reliability for the 30-trials task could not be calculated because of a negative average covariance and violated reliability model assumptions. The remaining tasks yielded test-retest reliability estimates of 0.32 for the 40-trial test and 0.59 for the 60 trial-test.

The ANOVA performed to assess dual-task competition on participants' global switch costs yielded a significant effect for the condition factor, F(1,55)=44.53, p.<0.0001, pη2=0.44. The average switch-cost score was 89.96 ms during the single-task, sitting condition and 209.37 ms during the dual-task, stepping condition. There was no significant difference in performance among the three groups. The global switch costs were 124 ms, 123 ms and 123 ms for the 30-, 40-, and 60-trial conditions respectively. Paired t-test analyses for the 19 participants assigned to the 30-trial condition revealed a t=−3.00, p.=0.008; for the 18 participants assigned to the 40-trial condition a t=−4.19, p.=0.001; and for the 21 participants assigned to the 60-trial condition a t=−5.18, p.<0.001. The ANOVA performed on participants' percent-error scores yielded a significant effect for the condition factor, F(1,56)=64.69, p.<0.001, pη2=0.54. The average percent-error score was 3.10 during the single-task, sitting condition and 6.82 during the dual-task, stepping condition. There was no significant difference in performance among the groups. Paired t-test analyses for the 19 participants assigned to the 30-trial condition revealed a t=−5.33, p.=<0.001; for the 18 participants assigned to the 40-trial condition a t=−3.78, p.=0.001; and for the 22 participants assigned to the 60-trial condition a t=−4.96, p.<0.001.

The experiment allowed the inventors to evaluate the reliability of a single index of executive functioning (task switching), across multiple task parameters and at multiple time points. It also allowed the inventors to assess dual-task interference in task switching that arises when individuals simultaneously perform a motor task and a cognitive task. Analyses of the reliability of global switch-cost scores were shown to have acceptable reliability across a period of one week (range=0.64-0.86) and that the reliability improved with longer test-trial lengths. While the test-retest reliability estimates of switch-cost scores were only marginally acceptable for one test configuration across a period of approximately seven months (range=0.32-0.59), the results are encouraging when compared to the reliabilities of the computer-based test batteries over a longer test re-test period and given the relatively small sample size evaluated.

Participants' switch-task performance was affected systematically when performed simultaneously with a stair-stepping task (modified Harvard step test). The switch cost interference was substantial, increasing from an average of around 86.38 ms in the single-task condition to an average of around 209.75 ms in the dual-task condition, and suggestive that the switch index may provide researchers with a common metric to assess the influence of different types of perturbation on cognitive function. Further, the magnitude of the effect was virtually identical across participants assigned to three different test-length conditions. The observed interference could be explained by capacity theories of attention. As long as the attentional resources exceed the attentional demands of the concurrent tasks, performance of the tasks will be allowed to proceed without degradation. If, however, the attentional demands of multiple tasks exceed the available attentional resources, interference occurs. Individuals suffering from a concussion may show a decline in the capacity of the attentional resources that are available.

As expected, the number of response errors was higher during dual-task conditions than single-task conditions; however, the overall percentage of errors was relatively low under both single (3.15%) and dual (6.82%) conditions. Of note, was the lack of a speed-accuracy tradeoff between switch-cost scores and response errors, which often occurs when individuals attempt to maintain or reduce response time but at the cost of increasing errors. However, the inventors postulate that the error rate could be much higher when evaluating post-concussion patients in which there is cognitive impairment. In this experiment, dual-task demands led to a general increase in mental processing time and response errors. These could be important measures when tracking concussion recovery.

The terminology used herein is for the purpose of describing particular implementations only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The implementation was chosen and described to best explain the principles of the invention and the practical application, and to enable others of ordinary skill in the art to understand the invention for various implementations with various modifications as are suited to the particular use contemplated.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to implementations of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The implementation was chosen and described in order to best explain the principles of the invention and the practical application, and to enable others of ordinary skill in the art to understand the invention for various implementations with various modifications as are suited to the particular use contemplated.

1. A method for facilitating determination of a mental deficiency in a patient by a health service provider, the method comprising:
instructing the patient to perform a cognitive task;
instructing the patient to perform a motor task while performing the cognitive task, said motor task being a non-reflex task;
determining a baseline performance on the cognitive and motor tasks;
at a later time, again instructing the patient to perform the cognitive task;
at the later time, again instructing the patient to perform the motor task while performing the second cognitive task;
determining a diagnostic performance on the cognitive and motor tasks;
comparing the diagnostic performance with the baseline performance to generate a comparison profile; and
communicating the comparison profile to the health service provider for use in determining the mental deficiency.

2. A method of claim 1, wherein the non-reflex task simulates a sport activity.

3. A method of claim 2, wherein the sport activity includes a series of foot placements.

4. A method of claim 3, wherein the foot placements are steps.

5. A method of claim 4, wherein the steps are steps up and down.

6. A method of claim 5, wherein the steps up and down are onto and off of an object.

7. A method of claim 6, further comprising providing the object.

8. A method of claim 7, wherein the sport activity includes a modified Harvard step test.

9. A method of claim 8, wherein the object is at least 8 inches high.

10. A method of claim 1, wherein the non-reflex task includes repeated intervals initiated by the patient.

11. A method of claim 10, wherein the intervals initiated by the patient are steps.

12. A method of claim 11, wherein instructing the patient includes instructing the patient to perform a series of steps.

13. A method of claim 1, further comprising presenting a series of symbols.

14. A method of claim 13, wherein presenting the series of symbols includes audibly presenting a series of numbers.

15. A method of claim 14, further comprising receiving a response from the patient characterizing each of the series of numbers.

16. A method of claim 15, wherein the response characterizes each of the numbers as odd or even.

17. A method of claim 13, wherein presenting the series of symbols includes audibly presenting a series of letters.

18. A method of claim 17, further comprising receiving a response from the patient characterizing each of the series of letters.

19. A method of claim 18, wherein the response characterizes each of the letters as a vowel or a consonant.

20. A method of claim 13, wherein presenting the series of symbols includes audibly presenting a series of letters and numbers to the patient.

21. A method of claim 20, wherein presenting the series of letters and numbers includes switching between vowels and consonants and between odd and even numbers.

22. A method of claim 20, wherein the vowels, consonants, odd numbers, and even numbers are presented in series of more than one before switching.

23. A method of claim 22, wherein presenting includes switching at least 20 times.

24. A method of claim 22, wherein the series is a series of at least four vowels, consonants, odd numbers, and even numbers.

25. A method of claim 22, wherein switching results in a cost interference of greater than 200 ms.

26. A method of claim 1, wherein at the later time is after a concussion.
